(19) United States
(12) Patent Application Publication
(10) Pub. No.: US 2019/0366566 A1
(43) Pub. Date: Dec. 5, 2019

(54) FOLDING TOOL ASSEMBLIES

(71) Applicant: REEVE INCORPORATED, Boise, ID (US)

(72) Inventor: William W. Harsey, Creswell, OR (US)

(21) Appl. No.: 16/418,126

(22) Filed: May 21, 2019

Related U.S. Application Data
(60) Provisional application No. 62/678,799, filed on May 31, 2018.

(51) Int. Cl. B26B 1/04

(52) U.S. Cl. CPC B26B 1/044

(57) ABSTRACT

A folding tool assembly rotates a folding tool that is pivotally coupled to a handle of the folding tool assembly either into the handle in a closed configuration or out of the handle in an open configuration about a pivot point. The folding tool assembly may include a spring comprising a fixed end and a free end, wherein the spring is disposed within the handle, and the fixed end of the spring is affixed to an end of the handle. The free end of the spring is configured to engage a tang of the folding tool. The initial amount of force applied to rotate the folding tool to the open configuration from the closed configuration is less than the initial amount of force applied to rotate the folding tool to the closed configuration from the open configuration.

### TECHNICAL FIELD

The present disclosure relates generally to the field of folding tools. In particular, some embodiments relate to components of pocket knives. More particularly, certain embodiments relate to components of non-locking pocket knives.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1 illustrates a perspective view of an embodiment of a folding tool assembly.

FIG. 2 illustrates a side view of the folding tool assembly of FIG. 1 in a closed configuration.

FIG. 3 illustrates a side view of the folding tool assembly of FIG. 1 in an open configuration.

FIG. 4 illustrates an exploded view of the folding tool assembly of FIG. 1.

FIG. 5 illustrates a side view of the folding tool assembly of FIG. 1 in a closed configuration with the front cover of the handle removed.

FIG. 5A illustrates a detailed view of the engagement between a tang of a folding tool and a slip joint spring.

FIG. 6 illustrates a side view of the folding tool assembly of FIG. 1 in a partially-opened configuration with the front cover of the handle removed.

FIG. 6A illustrates a detailed view of the engagement between a tang of a folding tool and a slip joint spring.

FIG. 7 illustrates a side view of the folding tool assembly of FIG. 1 in a closed configuration with the front cover of the handle removed.

FIG. 7A illustrates a detailed view of the engagement between a tang of a folding tool and a slip joint spring.

### DETAILED DESCRIPTION

The components of the embodiments as generally described and illustrated in the figures herein can be arranged and designed in a wide variety of different configurations. Thus, the following more detailed description of various embodiments, as represented in the figures, is not intended to limit the scope of the present disclosure, but is merely representative of various embodiments. While various aspects of the embodiments are presented in drawings, the drawings are not necessarily drawn to scale unless specifically indicated.

The phrase “coupled to” is broad enough to refer to any suitable coupling or other form of interaction between two or more entities, including mechanical interaction. Thus, two components may be coupled to each other even though they are not in direct contact with each other. The phrases “attached to” and “attached directly to” refer to interaction between two or more entities which are in direct contact with each other and/or are separated from each other only by a fastener of any suitable variety (e.g., mounting hardware or an adhesive).

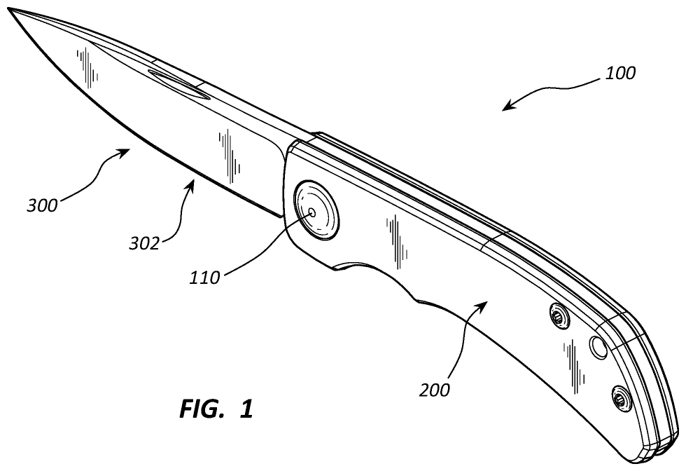

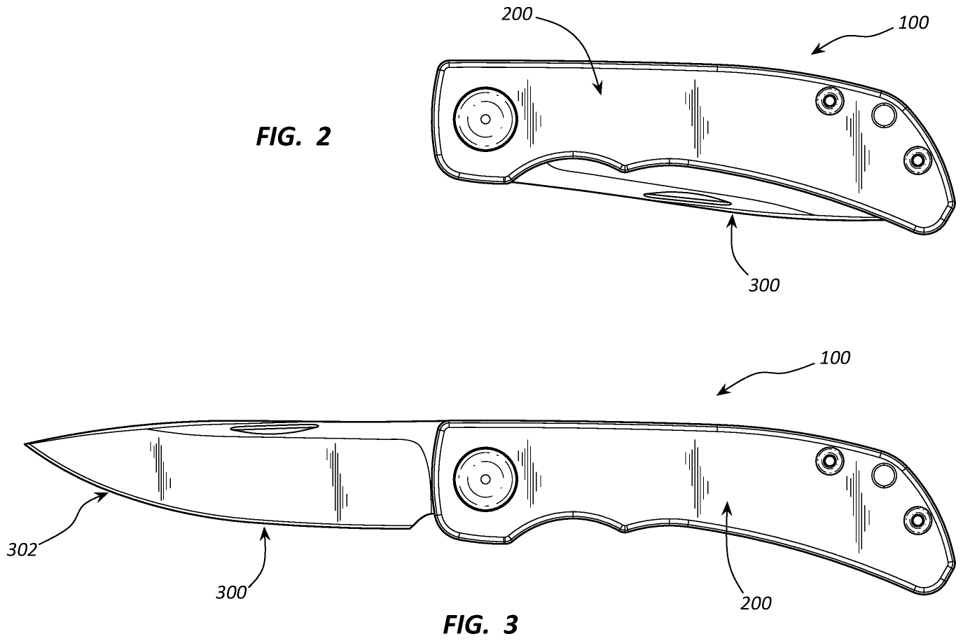

FIG. 1 provides a perspective view of a folding tool assembly 100 according to an embodiment. The folding tool assembly 100 may include a cover or handle 200 and a folding tool 300. In the illustrated embodiments, the folding tool 300 may be a knife or cutting element 302; however, the present disclosure is not so limited. The folding tool 300 may include a tool such as scissors, pliers, wire cutter, electrical crimper, wire stripper, saw, ruler, elongate element, rod, can opener, bottle opener, screwdriver, file, and the like. In some embodiments, the folding tool assembly 100 may include a plurality of folding tools. For example, the folding tool assembly may include a knife, scissors, pliers, can opener, screwdriver, and the like. The folding tool 300 may be positioned in a closed configuration as illustrated in FIG. 2 or an open configuration as illustrated in FIG. 3. The folding tool 300 may be pivotally coupled to the handle 200 such that the folding tool 300 is rotatable either into the handle 200 in the closed configuration or out of the handle 200 in an open configuration about a pivot point 110. A range of rotation of the folding tool 300 may range from about 160° to about 200°. In some embodiments, the folding tool assembly 100 does not include a locking feature to keep the folding tool 300 in the open configuration after the folding tool 300 has been rotated into the open configuration. In certain other embodiments, the folding tool assembly 100 may include a locking feature to keep the folding tool 300 in the open configuration after the folding tool 300 has been rotated into the open configuration.

In some embodiments of the folding tool assembly 100, the initial amount of force to rotate the folding tool 300 from the closed configuration to the open configuration is less than the initial amount of force to rotate the folding tool 300 from the open configuration to the closed configuration. In other words, the initial amount of force to rotate the folding tool 300 from the open configuration to the closed configuration is greater than the initial amount of force to rotate the folding tool 300 from the open configuration to the closed configuration. This may result in a non-locking knife that is less likely to close unintentionally.

The amount of force to open and close the folding tool assembly 100 is a parameter that is important for users. In some embodiments, the initial amount of force to rotate the cutting element 302 to the open configuration from the closed configuration equates to about one pound of force. In some embodiments, the initial amount of force to rotate the folding tool 300 to the closed configuration from the open configuration equates to more than two pounds of force. In some embodiments, the initial amount of force to rotate the folding tool 300 to the closed configuration from the open configuration equates to about five pounds of force.

In some embodiments, a ratio between the initial amount of force applied to rotate the folding tool 300 to the open configuration from the closed configuration to the initial amount of force applied to rotate the folding tool 300 to the closed configuration from the open configuration is greater than about 1:2. In various other embodiments, the ratios may be selected from, for example, about 1:2, about 1:3, about 1:4, about 1:5, about 1:6, about 1:7, about 1:8, about 1:9, and about 1:10. In certain embodiments, the ratio may be selected from about 1:2 to about 1:6, about 1:3 to about 1:6, about 1:4 to about 1:6, about 1:4 to about 1:5, and about 1:5 to about 1:6. In particular embodiments, the ratio may range from 1:2 to 1:10, 1:3 to 1:7, or 1:4 to 1:6.

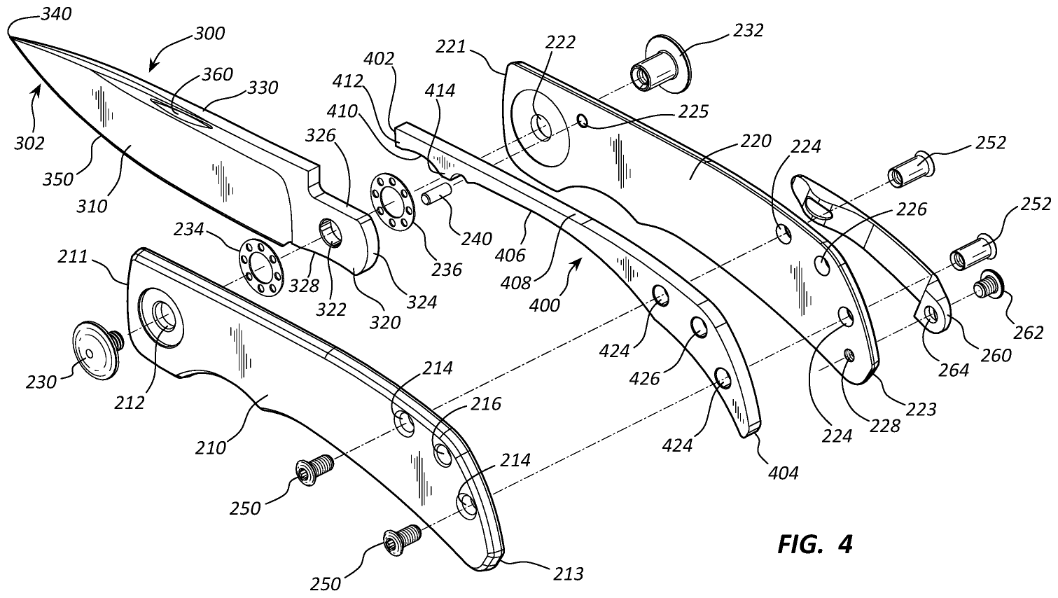

FIG. 4 illustrates an exploded view of the folding tool assembly 100 of FIG. 1. As discussed previously, the folding tool assembly 100 may include the handle 200 and the folding tool 300, such as, the cutting element 302. In the illustrated embodiment, the handle 200 may include a first plate 210 and a second plate 220. Each plate 210, 220 may include a first end 211, 221, and a second end 213, 223. Alternatively, in some embodiments, the handle 200 may be a unitary piece that comprises a housing for storing the cutting element 302 within.

The first plate 210 and the second plate 220 may be coupled together to create a housing to store the cutting element 302 within when the cutting element 302 is not in use or when the folding tool assembly is in a closed configuration. The plates 210, 220 may be coupled together by various fastening elements, such as bolts, screws, nuts, washers, nuts, rivets, and the like. In some embodiments, the plates 210, 220 may be coupled together via adhesives, epoxies, resins, and the like. For example, fasteners 230, 232 may couple the first plate 210 and the second plate 220 together via apertures 212, 222 disposed on the first ends 211, 221 of the handle 200. Additional fasteners 250, 252 may couple the first plate 210 and the second plate 220 together via apertures 214, 224 disposed on the second ends 213, 223 of the handle 200.

In some embodiments, the handle 200 may include a clip 260. The clip may be coupled to the handle 200 via fastener 262 that engages aperture 264 of clip 260 and aperture 228 of second plate 220. The clip 260 may be disposed near the second end 223 of the second plate 220. The clip 260 may enable a user to clip the folding tool assembly 100 to a pocket of a user's pants, or another suitable location.

In some embodiments, the first plate 210 and the second plate 220 may further include other apertures 216, 226. Apertures 216, 226 may enable a user to attach a key ring or chain through the apertures 216, 226 to enable the user to carry the folding tool assembly 100 on a keychain, bag, backpack, or other suitable location.

The folding tool assembly 100 may further include the cutting element 302. The cutting element 302 may include a blade 310 and a tang 320. The blade 310 may include a spine 330, a tip 340, and an edge 350. The spine 330 may be the thickest part of the blade 310 and may be configured to provide strength to the edge 350 of the blade 310. The edge 350 is the working part of the blade 310 for cutting and may have a variety of different profiles. For example, the edge 350 may be a chisel, hollow-ground, V or flat-ground, convex, compound, or serrated. The edge 350 may include multiple bevels, such as half hollow-ground and half serrated. The tip 340 is the sharp end of the blade 310 that tapers to a point. The tip 340 may be a trail point, clip point, drop point, spear point, hawksbill point, tanto point, etc. In some embodiments, the tip 340 may include a swedge.

The cutting element 302 may further include a nail mark 360. The nail mark 360 may enable a user to grip the cutting element 302 and apply the initial amount of force or torque needed to rotate the cutting element 302 from the closed configuration to the open configuration. The nail mark 360 may be disposed in various positions near the spine 330 of the blade 310.

The tang 320 of the cutting element 302 may include a side portion 326, an end portion 324, and a side portion 328. The tang 320 may define an aperture 322 through which the cutting element 302 may be coupled to the handle 200. For example, the fasteners 230, 232 may couple the cutting element 302 to the handle 200 near the first ends 211, 221 of the handle 200, and washers 234, 236 may be disposed between the cutting element 302 and the first plate 210 and between the cutting element 302 and the second plate 220. The aperture 322 may be concentric with the pivot point 110 of cutting element 302. The end portion 324 of the tang 320 may include a convex curve.

In some embodiments, the length of the side portion 326 from the center of the aperture 322 to the end portion 324 is different from the length of the side portion 328 from the center of the aperture 322 to the end portion 324. In some embodiments, the length of the side portion 326 from the center of the aperture 322 to the end portion 324 is greater than the length of the side portion 328 from the center of the aperture to the end portion 324. In some embodiments, the side portion 328 has a concave curve.

In some embodiments, the difference in the amount of force applied to open and close the cutting element 302 may be accomplished by a slip joint spring 400. The spring 400 may be substantially planar and extend a majority of the length of the handle 200. The spring 400 may be fabricated from a metal, alloy, or other suitable material. In some embodiments, the spring 400 may be disposed within the handle 200. In some embodiments, the spring 400 may be partially disposed within the handle 200. In some embodiments, the spring 400 may extend out of the handle 200 during rotation of the cutting element 302.

The spring 400 may include an inner portion 406 and an outer portion 408. The spring 400 may include a first end or working end 402 and a second end or anchored end 404. The second end or anchored end 404 may include apertures 424, 426 that are configured to help couple the second end or anchored end 404 of the spring 400 to the handle 200. The first end or working end 402 of the spring 400 may be a free end and is configured to engage with the tang 320 of the cutting element 302 and apply a predetermined pressure load to the tang 320. The second end or anchored end 404 of the spring 400 may be a fixed end to enable the first end or working end 402 to be displaced.

The first end or working end 402 of the spring 400 may further include a recurve 410 disposed in the inner portion 406 and may include lobes 412, 414 disposed on opposing ends of the recurve 410. Each lobe 412, 414 provides a pressure load to the tang 320 of the cutting element 302. The first end or working end 402 of the spring may function as a cam to provide the pressure loads to the tang 320 of the cutting element 302. In some embodiments, the pressure loads provided by the lobes 412, 414 may be different.

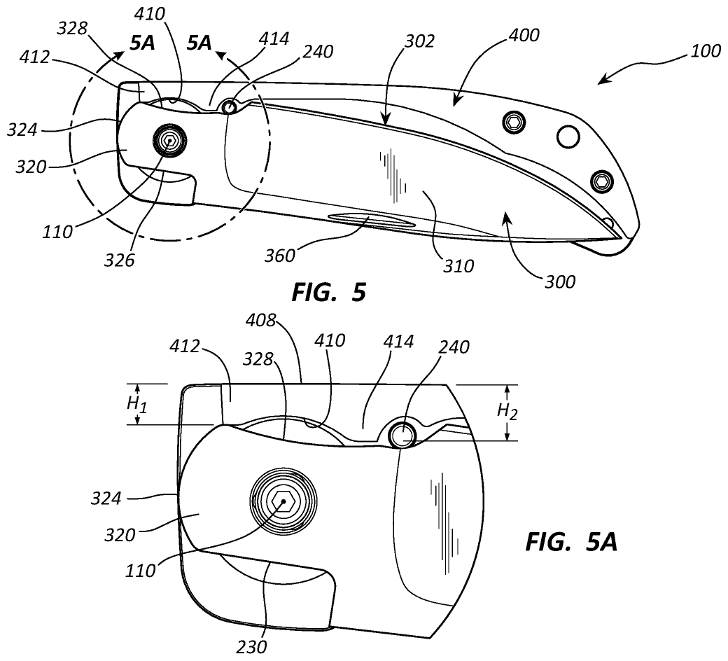

In some embodiments, the folding tool assembly 100 may further include a dowel pin 240 disposed within the housing and between the spring 400 and the cutting element 302. The dowel pin 240 may be configured to be coupled to the second plate 220 via an aperture 225. The dowel pin 240 is configured to engage the cutting element 302, as illustrated in FIGS. 5 and 5A and prevent the cutting element 302 from coming in contact with the spring 400 when the cutting element 302 is in the closed configuration.

FIGS. 5, 5A, 6, 6A, 7, and 7A illustrate the process of opening the folding tool assembly 100 from the closed configuration to the open configuration. These figures also illustrate the process of closing the folding tool assembly 100 from the open configuration to the closed configuration when considered in reverse order.

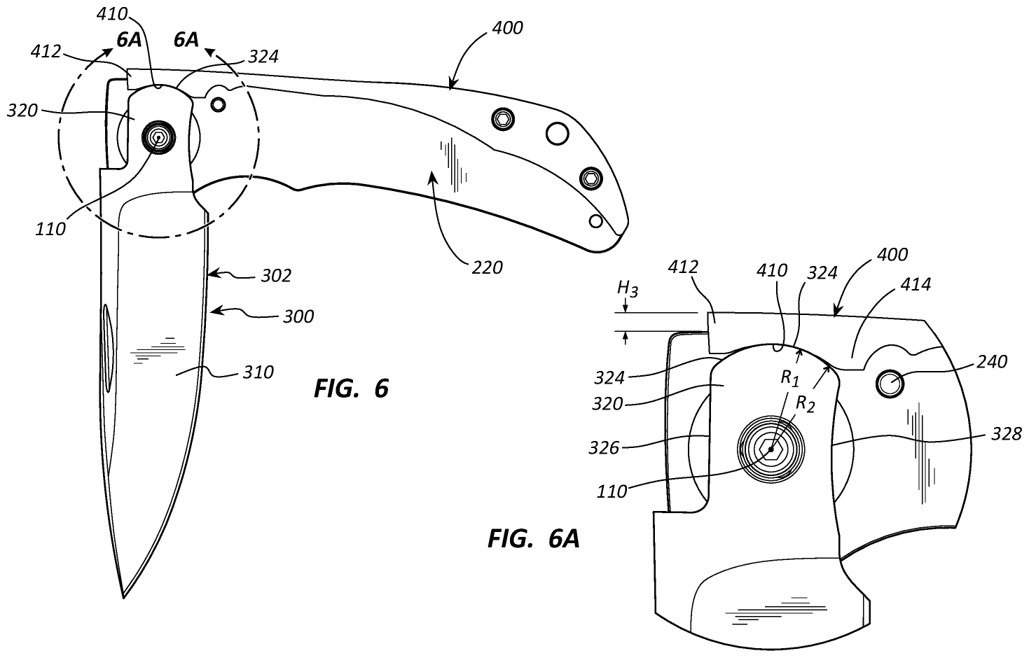

FIGS. 5 and 5A illustrate the folding tool assembly 100 in the closed configuration. In the closed configuration, the side portion 328 of the tang 320 engages a first lobe 412 of the spring 400. As illustrated in FIG. 5A, the first lobe 412 has a different height H1 than a second lobe 414, H2. The difference in height contributes to the differing pressure loads provided by the different lobes 412, 414 of the spring 400. The height of each lobe 412, 414 is measured from the outer portion 408 of the spring 400. In some embodiments, the height of the first lobe 412 is less than the height of the second lobe 414, thus the pressure load from the first lobe 412 of the spring 400 is less than the pressure load form the second lobe 414 of the spring 400. In some embodiments, the height difference between the first lobe 412 and the second lobe 414 ranges between 0.05 and 0.75 inches. A user may apply a force to the cutting element 302 to initiate the opening process. As the user applies the force, the spring 400 is configured to displace upward and, in some embodiments, extend out of the handle 200 (as illustrated in FIG. 6A). While the spring 400 is also configured to remain engaged with the tang 320 of the cutting element 302, the spring 400 may also be displaced relative to the tang 320. As discussed previously, the initial amount of force to open the cutting element may be about one pound of force.

FIGS. 6 and 6A illustrate the cutting element 302 in a partially-opened configuration. After the tang 320 overcomes the first pressure load of the first lobe 412, the concave curve of the end portion 324 of the tang 320 engages with the recurve 410 of the spring 400. As illustrated in FIG. 6A, a radius R2 of the concave curve of the end portion 324 of the tang is less than a radius R1 of the convex curve of the recurve 410. Since radius R2 is less than R1, the end portion 324 of the tang 320 creates a single point of contact with the recurve 410. In other words, there is no gap in contact between the end portion 324 of the tang 320 and the recurve 410. The single point of contact between the end portion 324 of the tang 320 and the recurve 410 creates a self-cleaning mechanism. Upon rotation of the cutting element 302, the end portion 324 of the tang 320 clears out debris, dirt, lint, etc. that is disposed on the recurve 410.

In some embodiments, the curve of the recurve 410 is not a constant radius, but has a progressively changing radius. For example, the radius of the recurve 410 near the first lobe 412 is greater than the radius of the recurve 410 near the second lobe 414. In some embodiments, the radius of the recurve 410 near the first lobe 412 is less than the radius of the recurve 410 near the second lobe 414.

In some embodiments, the center of radius R1 is not concentric with the radius R2 or with the pivot point 110. In some embodiments, the center of radius R2 is not concentric with the radius R1 or with the pivot point 110.

The height of the recurve 410 progressively changes over the length of the recurve 410 and is less than both of the lobes 412, 414. Because of the smaller height, the pressure load on the tang 320 is less than either of the lobes 412, 414, thus making the rotation of the cutting element 302 smooth after clearing the pressure load of the first lobe 412. In addition, during rotation of the cutting element 302, the spring 400 is configured to extend out of the handle 200. FIG. 6A illustrates the height of the spring 400 out of the handle 200 as H3 when the cutting element 302 is rotated 90°; however, the height that the spring 400 extends out of the handle 200 varies over the range of rotation of the cutting element 302. For example, Table 1 below represents an exemplary spring 400 displacement during the range of rotation, which corresponds with H3.

TABLE 1

| Rotation of Cutting Element | Spring Displacement |
|---|---|
| 0° | 0.000″ |
| 15° | 0.065″ |
| 30° | 0.082″ |
| 45° | 0.092″ |
| 60° | 0.093″ |
| 75° | 0.087″ |
| 90° | 0.083″ |
| 105° | 0.081″ |
| 120° | 0.080″ |
| 135° | 0.073″ |
| 150° | 0.060″ |
| 165° | 0.024″ |
| 180° | 0.0″ |

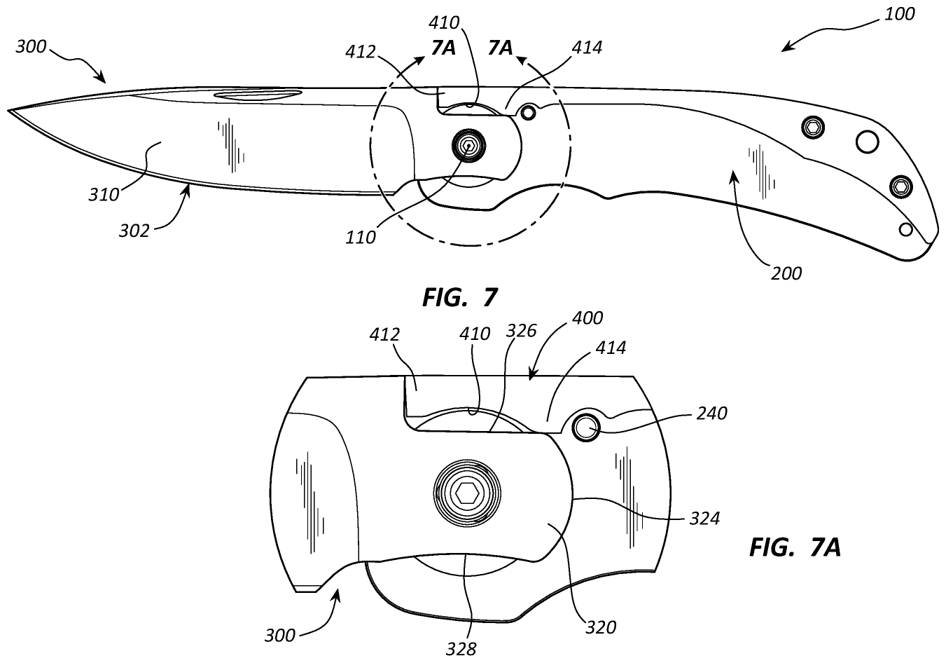

FIGS. 7 and 7A illustrate the folding tool assembly 100 in the opened configuration. In the opened configuration, the side portion 326 of the tang 320 engages the second lobe 414 of the spring 400. The difference in height between the lobes 412, 414 contributes to the differing pressure loads provided by the different lobes 412, 414 of the spring 400. A user may apply a force to the cutting element 302 to initiate the opening process. As the user applies the force, the spring 400 is configured to displace upward and, in some embodiments, extend out of the handle 200 (as illustrated in FIG. 6A). While the spring 400 is also configured to remain engaged with the tang 320 of the cutting element 302, the spring 400 may also be displaced relative to the tang 320. As discussed previously, the initial amount of force to close the cutting element 302 may be about five pounds of force.

Any methods disclosed herein include one or more steps or actions for performing the described method. The method steps and/or actions may be interchanged with one another. In other words, unless a specific order of steps or actions is required for proper operation of the embodiment, the order and/or use of specific steps and/or actions may be modified. Moreover, sub-routines or only a portion of a method described herein may be a separate method within the scope of this disclosure. Stated otherwise, some methods may include only a portion of the steps described in a more detailed method.

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated by one of skill in the art with the benefit of this disclosure that in the above description of embodiments, various features are sometimes grouped together in a single embodiment, figure, or description thereof for the purpose of streamlining the disclosure. This method of disclosure, however, is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. Elements recited in means-plus-function format are intended to be construed in accordance with 35 U.S.C. § 112(f). It will be apparent to those having skill in the art that changes may be made to the details of the above-described embodiments without departing from the underlying principles of the present disclosure.

We claim:

1. A folding tool assembly comprising:
a handle;
a folding tool comprising a tool and a tang, wherein the folding tool is pivotally coupled to a first end of the handle such that the folding tool is rotatable either into the handle in a closed configuration or out of the handle in an open configuration about a pivot point; and
a spring comprising a fixed end and a free end, wherein the spring is disposed within the handle, wherein the fixed end of the spring is affixed to a second end of the handle, and wherein the free end of the spring is configured to engage the tang of the folding tool,
wherein the initial amount of force applied to rotate the folding tool to the open configuration from the closed configuration is less than the initial amount of force applied to rotate the folding tool to the closed configuration from the open configuration.

2. The folding tool assembly of claim 1, wherein a ratio between the initial amount of force applied to rotate the folding tool to the open configuration from the closed configuration to the amount of force applied to rotate the folding tool to the closed configuration from the open configuration is greater than about 1:2.

3-5. (canceled)

6. The folding tool assembly of claim 1, wherein an inner portion of the free end of the spring engages the tang of the folding tool, wherein the inner portion is opposite an outer portion of the spring, and wherein the inner portion of the free end of the spring comprises a recurve and opposing lobes disposed at opposing ends of the recurve.

7. The folding tool assembly of claim 6, wherein the recurve comprises a concave curve.

8. The folding tool assembly of claim 7, wherein a radius of the recurve progressively changes over the length of the recurve.

9. The folding tool assembly of claim 6, wherein an end of the tang that engages with the inner portion of the free end of the spring comprises a convex curve.

10. The folding tool assembly of claim 6, wherein a radius of a curve of the tang that engages with the inner portion of the free end of the spring is smaller than the radius of the curve of the recurve.

11. The folding tool assembly of claim 6, wherein a curve of the tang that engages with the inner portion of the first end of the spring self-cleans the recurve upon rotation of the folding tool.

12. The folding tool assembly of claim 6, wherein a curve of the tang that engages with the inner portion of the first end of the spring has a single point of contact with the recurve during rotation of the folding tool.

13. The folding tool assembly of claim 1, wherein upon rotation of the folding tool, the free end of the spring is configured to extend out of the handle.

14. The folding tool assembly of claim 9, wherein a center of the radius of the convex curve of the tang is offset from the pivot point.

15. The folding tool assembly of claim 1, wherein a dowel pin is disposed between the folding tool and the spring and engages the folding tool when the folding tool is in the closed configuration.

16. The folding tool assembly of claim 1, wherein the handle comprises a first plate and a second plate, and the folding tool and the spring are disposed between the first plate and the second plate.

17. The folding tool assembly of claim 1, wherein the folding tool is a cutting element and the tool is a blade.

18. (canceled)

19. A slip joint spring for a pocket knife comprising:
a first end and a second end;
a plurality of apertures defined in the second end, wherein the apertures are configured to enable the slip joint spring to be fixed to a handle of the pocket knife;
a recurve disposed on an inner portion of the first end, wherein the inner portion is opposite an outer portion, wherein the recurve has a concave curve; and
opposing lobes disposed on the inner portion on opposing ends of the recurve,
wherein a height of each of the opposing lobes is different, and wherein the height of each lobe is measured from the outer portion of the slip joint spring.

20. The slip joint spring of claim 19, wherein a height of a first lobe disposed closer to the first end is less than a height of a second lobe that is further from the first end.

21. The slip joint spring of claim 19, wherein the difference in height between the opposing lobes ranges between 0.05 and 0.075 inches.

22. The slip joint spring of claim 19, wherein a radius of the recurve progressively changes over the length of the recurve.

23. A folding tool assembly comprising:
a handle;
a folding tool comprising a tool and a tang, wherein the folding tool is pivotally coupled to a first end of the handle such that the folding tool is rotatable either into the handle in a closed configuration or out of the handle in an open configuration about a pivot point; and
a biasing means for biasing the folding tool during rotation, wherein the biasing means changes the initial amount of force applied needed to rotate the folding tool, wherein the initial amount of force applied to rotate the folding tool to the open configuration from the closed configuration is less than the initial amount of force applied to rotate the folding tool to the closed configuration from the open configuration.

24. The folding tool assembly of claim 23, wherein a ratio between the amount of force applied to rotate the folding tool to the open configuration from the closed configuration to the amount of force applied to rotate the folding tool to the closed configuration from the open configuration is greater than about 1:2.

25-27. (canceled)
